(19) United States
(12) Patent Application Publication
(10) Pub. No.: US 2021/0264775 A1
(43) Pub. Date: Aug. 26, 2021

(54) SERVER, NON-TRANSITORY STORAGE MEDIUM, AND INFORMATION PROCESSING METHOD

(71) Applicant: TOYOTA JIDOSHA KABUSHIKI KAISHA, Toyota-shi (JP)

(72) Inventors: Takashige HORI, Aisai-shi (JP); Masaru WAKABAYASHI, Nagoya-shi (JP); Yoko SAKURAI, Toyohashi-shi (JP); Ken ISHIKAWA, Nagakute-shi (JP)

(73) Assignee: TOYOTA JIDOSHA KABUSHIKI KAISHA, Toyota-shi (JP)

(21) Appl. No.: 17/143,314

(22) Filed: Jan. 7, 2021

(30) Foreign Application Priority Data
Feb. 26, 2020 (JP) 2020-030924

(51) Int. Cl. G08G 1/01; G08G 1/017

(52) U.S. Cl. CPC G08G 1/0133; G08G 1/017; G08G 1/0112; G08G 1/0141

(57) ABSTRACT

A server includes a control unit configured to: determine based on probe data acquired by a first vehicle whether the first vehicle is parked or stopped on a road; determine based on probe data acquired by one or more second vehicles located near the first vehicle whether the first vehicle is affecting traffic flow on the road, when the control unit determines that the first vehicle is parked or stopped; and output an alert when the control unit determines that the first vehicle is affecting the traffic flow on the road.

### CROSS-REFERENCE TO RELATED APPLICATION

This application claims priority to Japanese Patent Application No. 2020-030924 filed on Feb. 26, 2020, incorporated herein by reference in its entirety.

### BACKGROUND

### 1. Technical Field

The present disclosure relates to a server, a non-transitory storage medium, and an information processing method.

### 2. Description of Related Art

A technique of detecting a vehicle parked or stopped on a road is known as a related art. For example, Japanese Unexamined Patent Application Publication No. 2019-133281 (JP 2019-133281 A) discloses an information processing device that determines from an image captured by an on-board device whether a vehicle in the captured image is stopped or parked.

### SUMMARY

In recent years, there has been a demand for further improvement in usefulness of the technique of detecting a vehicle parked or stopped on a road. For example, in addition to detecting a vehicle parked or stopped on a road, it has been desired to evaluate the influence of the detected vehicle on traffic flow on the road.

The present disclosure provides a server, a non-transitory storage medium, and an information processing method that improve the usefulness of the technique of detecting a vehicle parked or stopped on a road.

A server according to a first aspect of the present disclosure includes: a control unit configured to: determine based on probe data acquired by a first vehicle whether the first vehicle is parked or stopped on a road; determine based on probe data acquired by one or more second vehicles located near the first vehicle whether the first vehicle is affecting traffic flow on the road, when the control unit determines that the first vehicle is parked or stopped; and output an alert when the control unit determines that the first vehicle is affecting the traffic flow on the road.

A non-transitory storage medium according to a second aspect of the present disclosure stores instructions that are executable by one or more processors and that cause the one or more processors to perform functions. The functions include: determining based on probe data acquired by a first vehicle whether the first vehicle is parked or stopped on a road; determining based on probe data acquired by one or more second vehicles located near the first vehicle whether the first vehicle is affecting traffic flow on the road, when the one or more processors determine that the first vehicle is parked or stopped; and outputting an alert when the one or more processors determine that the first vehicle is affecting the traffic flow on the road.

A method for processing information by a computer according to a third aspect of the present disclosure includes: determining based on probe data acquired by a first vehicle whether the first vehicle is parked or stopped on a road; determining based on probe data acquired by one or more second vehicles located near the first vehicle whether the first vehicle is affecting traffic flow on the road, when the computer determines that the first vehicle is parked or stopped; and outputting an alert when the computer determines that the first vehicle is affecting the traffic flow on the road.

The server, the non-transitory storage medium, and the information processing method according to an embodiment of the present disclosure improve the usefulness of the technique of detecting a vehicle parked or stopped on a road.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a schematic configuration of an information processing system according to an embodiment of the present disclosure;

FIG. 2 schematically illustrates the positions of vehicles according to the embodiment;

FIG. 3 is a block diagram illustrating a schematic configuration of the vehicle according to the embodiment;

FIG. 4 is a block diagram illustrating a schematic configuration of a terminal device according to the embodiment;

FIG. 5 is a block diagram illustrating a schematic configuration of a server according to the embodiment; and

FIG. 6 is a flowchart illustrating operation of the server according to the embodiment.

### DETAILED DESCRIPTION OF EMBODIMENTS

An embodiment of the present disclosure will be described with reference to the accompanying drawings.

In the drawings, the same or corresponding portions are denoted with the same signs. In the description of the embodiment, description of the same or corresponding portions will be omitted or simplified.

### Configuration of Information Processing System

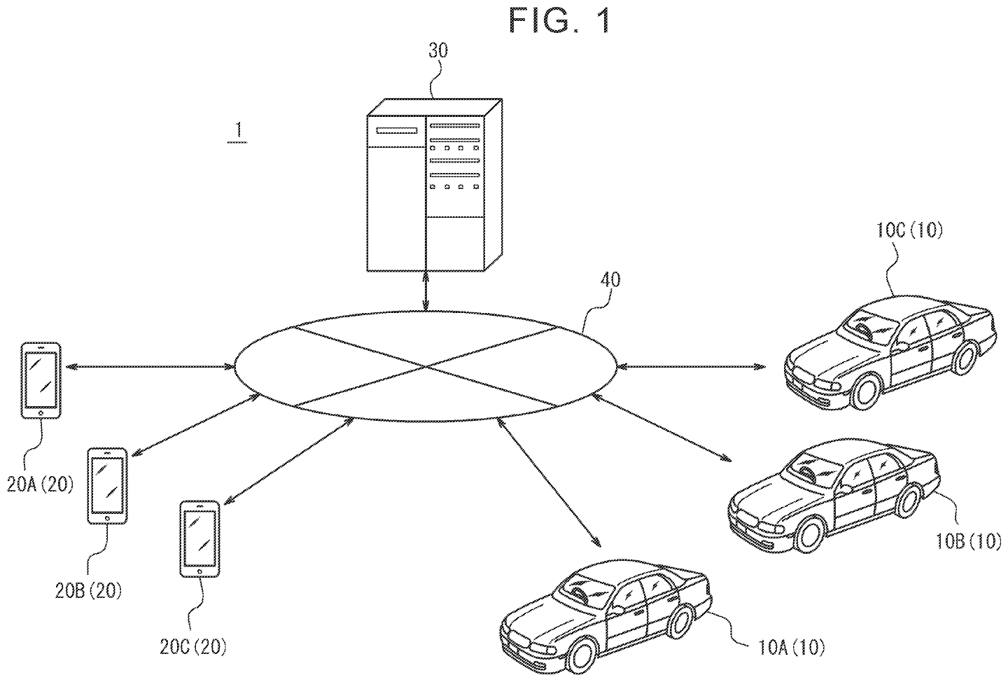

The configuration of an information processing system 1 according to the embodiment of the present disclosure will be outlined with reference to FIG. 1. As shown in FIG. 1, the information processing system 1 includes a vehicle 10, a terminal device 20, and a server 30. FIG. 1 illustrates three vehicles 10, three terminal devices 20, and one server 30. However, the information processing system 1 may include any numbers of vehicles 10, terminal devices 20, and servers 30.

The vehicle 10 is, e.g., an automobile. However, the vehicle 10 is not limited to an automobile, and may be any vehicle such as a motorcycle or a bicycle. In the present embodiment, the vehicles 10 include a first vehicle 10A, a second vehicle 10B, and a third vehicle 10C. Hereinafter, the first vehicle 10A, the second vehicle 10B, and the third vehicle 10C are simply referred to as the vehicles 10 unless individually identified.

The vehicle 10 may be driven by a driver or may be an automated vehicle at any level of driving automation. For example, the level of driving automation is one of levels 1 to 5 defined by the Society of Automotive Engineers (SAE).

The vehicle 10 sends probe data acquired by the vehicle 10 to the server 30. The probe data is, e.g., information detected by a sensor mounted on the vehicle 10 or a record of control of devices of the vehicle 10 such as a steering wheel, an accelerator, brakes, or lamps. The probe data includes, e.g., information indicating the position, speed, or driving state of the vehicle 10. The vehicle 10 may periodically and repeatedly send the probe data or may send the probe data at a desired timing.

The terminal device 20 is a computer such as a mobile phone, a smartphone, or a personal computer. In this specification, the computer is also referred to as an information processing device. In the present embodiment, the terminal device 20 is, e.g., the terminal device 20 that is used by a user of the vehicle 10. The user of the vehicle 10 is, e.g., an owner or driver of the vehicle 10. In the present embodiment, the terminal devices 20 include a terminal device 20A that is used by a user of the first vehicle 10A, a terminal device 20B that is used by a user of the second vehicle 10B, and a terminal device 20C that is used by a user of the third vehicle 10C. Hereinafter, the terminal device 20A, the terminal device 20B, and the terminal device 20C are simply referred to as the terminal devices 20 unless individually identified.

The server 30 is composed of one or more computers. In the present embodiment, it is assumed that the server 30 is composed of one computer. However, the server 30 may be an information processing system, such as a cloud computing system, composed of a plurality of computers. In the present embodiment, the server 30 collects and accumulates the probe data acquired by the vehicles 10. The server 30 carries out data analysis based on the collected probe data and sends the analysis result to the vehicles 10 or the terminal devices 20 to provide the users etc. with information.

A network 40 is any communication network with which the vehicles 10, the terminal devices 20, and the server 30 can communicate. The network 40 may be a wireless or wired transmission path or may be a communication network such as the Internet. In the present embodiment, the network 40 may be, e.g., an ad hoc network, a metropolitan area network (MAN), a cellular network, a wireless personal area network (WPAN), a public switched telephone network (PSTN), a terrestrial wireless network, an optical network, other network, or any combination of these.

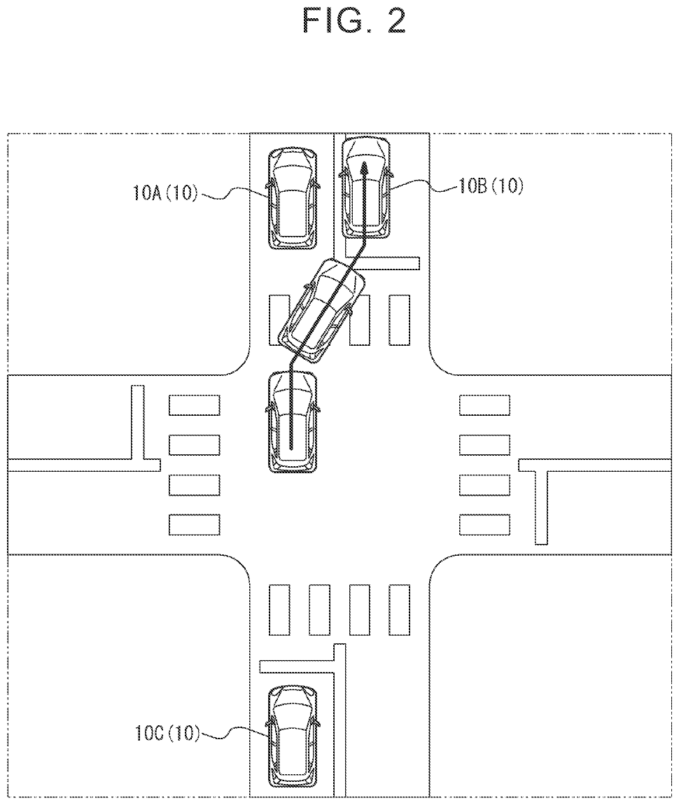

Operation of the information processing system 1 will be outlined with reference to FIG. 2. The information processing system 1 is used for a service that provides the user with information about the vehicle 10 parked/stopped on a road. In this specification, the vehicle 10 “parked or stopped” on a road is also referred to as the vehicle 10 “parked/stopped” on a road.

The server 30 collects and accumulates the probe data sent from the vehicles 10. The server 30 determines based on the probe data acquired by each vehicle 10 whether each vehicle 10 is parked/stopped on a road. When the server 30 determines that the first vehicle 10A out of the vehicles 10 is parked/stopped, the server 30 determines based on the probe data acquired by the second vehicle 10B located near the first vehicle 10A whether the first vehicle 10A is affecting traffic flow on the road. For example, when the server 30 determines based on the probe data acquired by the second vehicle 10B that the second vehicle 10B has been maneuvered to avoid the first vehicle 10A, the server 30 determines that the first vehicle 10A is affecting the traffic flow on the road. When the server 30 determines that the first vehicle 10A is affecting the traffic flow on the road, the server 30 sends an alert to the user of the first vehicle 10A or the user of the third vehicle 10C that is going to travel near the first vehicle 10A. The alert is output to the vehicle 10 or the terminal device 20 that is used by the user of the vehicle 10.

The information processing system 1 thus provides the user with information on the vehicle 10 that is affecting the traffic flow on the road out of the vehicles 10 parked/stopped on the road. The information processing system 1 thus improves the usefulness of the technique of detecting the vehicle 10 parked/stopped on a road.

Next, the vehicle 10, the terminal device 20, and the server 30 included in the information processing system 1 will be described in detail.

### Configuration of Vehicle

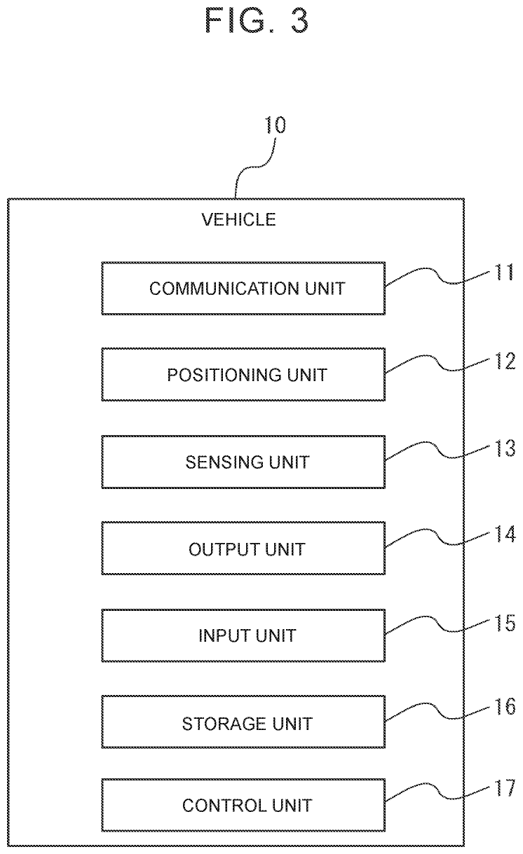

The configuration of the vehicle 10 according to the present embodiment will be described with reference to FIG. 3. As shown in the block diagram of FIG. 3, the vehicle 10 includes a communication unit 11, a positioning unit 12, a sensing unit 13, an output unit 14, an input unit 15, a storage unit 16, and a control unit 17. The communication unit 11, the positioning unit 12, the sensing unit 13, the output unit 14, the input unit 15, the storage unit 16, and the control unit 17 are connected via an on-board network such as a controller area network (CAN) or a dedicated line so that they can communicate with each other.

In the present embodiment, it is assumed that an on-board device mounted on the vehicle 10 includes the communication unit 11, the positioning unit 12, the sensing unit 13, the output unit 14, the input unit 15, the storage unit 16, and the control unit 17. The on-board device is, e.g., a car navigation system. However, the on-board device is not limited to the car navigation system and may be, e.g., an electronic control unit (ECU), an on-board communication device, or a combination thereof.

The communication unit 11 includes a communication module for connecting to the network 40. The communication module is a communication module compliant with a mobile communication standard such as 4th generation (4G) or 5th generation (5G). The communication module may be a communication module compliant with a standard such as a wired local area network (LAN) or a wireless LAN. The communication module may be a communication module compliant with a short-range wireless communication standard such as Wi-Fi (registered trademark), Bluetooth (registered trademark), or infrared communication. In the present embodiment, the vehicle 10 is connected to the network 40 via the communication unit 11. The vehicle 10 can thus communicate with the server 30 etc.

The positioning unit 12 measures the position of the vehicle 10 and generates position information. In the present disclosure, the position information includes, e.g., coordinates such as two-dimensional coordinates or three-dimensional coordinates. The positioning unit 12 includes a receiver for a satellite positioning system. This satellite positioning system may be, e.g., a global positioning system (GPS). The positioning unit 12 may include, e.g., an acceleration sensor or a gyro sensor.

The sensing unit 13 includes one or more sensors. The sensor is, e.g., a speed sensor, an acceleration sensor, a gyro sensor, an image sensor, or an infrared sensor. The sensing unit 13 observes an event such as speed, acceleration, angular velocity, an image of the surroundings of the vehicle 10, or whether there is an obstacle around the vehicle 10, and obtains an observed value.

The output unit 14 outputs information in the form of, e.g., an image, text, or sound. The output unit 14 includes an output device such as a display or a speaker.

The input unit 15 receives an input operation. The input unit 15 includes an input device such as a touch panel, physical keys, a camera, a microphone, or an IC card reader.

The storage unit 16 is, e.g., a semiconductor memory, a magnetic memory, or an optical memory. The storage unit 16 may function as, e.g., a main storage device, an auxiliary storage device, or a cache memory. The storage unit 16 stores any information that is used for operation of the vehicle 10. The storage unit 16 stores, e.g., a system program, an application program, or embedded software. The information stored in the storage unit 16 may be updatable with, e.g., information that is acquired from the network 40 via the communication unit 11.

The control unit 17 includes one or more processors. The processor may be, e.g., a general-purpose processor such as a central processing unit (CPU) or a dedicated processor specialized in specific processing. The control unit 17 need not necessarily include the processor(s) and may include one or more dedicated circuits. The dedicated circuit may be, e.g., a field-programmable gate array (FPGA) or an application specific integrated circuit (ASIC). The control unit 17 controls the above components such as the communication unit 11, the positioning unit 12, the sensing unit 13, the output unit 14, the input unit 15, and the storage unit 16 in order to implement functions of the vehicle 10 including functions of these components.

The control unit 17 of the vehicle 10 sends the probe data acquired by the vehicle 10 to the server 30 via the communication unit 11. The probe data may include the position information generated by the positioning unit 12 or the observed value obtained by the sensing unit 13, or a record of control of each function of the vehicle 10 by the control unit 17. The vehicle 10 may periodically and repeatedly send the probe data or may send the probe data at a desired timing. In the present embodiment, it is assumed that the vehicle 10 directly sends the probe data acquired by the vehicle 10 to the server 30. However, the vehicle 10 may indirectly send the probe data acquired by the vehicle 10 to the server 30 via a data collection service etc.

### Configuration of Terminal Device

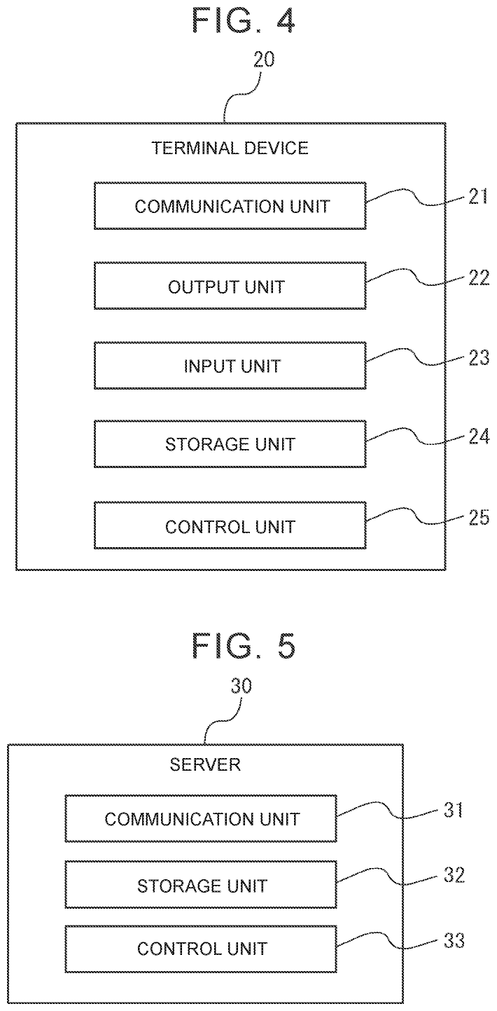

The configuration of the terminal device 20 according to the present embodiment will be described with reference to FIG. 4. As shown in the block diagram of FIG. 4, the terminal device 20 includes a communication unit 21, an output unit 22, an input unit 23, a storage unit 24, and a control unit 25. The communication unit 21, the output unit 22, the input unit 23, the storage unit 24, and the control unit 25 are connected wired or wireless so that they can communicate with each other.

The communication unit 21 includes a communication module for connecting to the network 40. The communication module is a communication module compliant with a mobile communication standard such as 4G or 5G. The communication module may be a communication module compliant with a standard such as a wired LAN or a wireless LAN. The communication module may be a communication module compliant with a short-range wireless communication standard such as Wi-Fi, Bluetooth, or infrared communication. In the present embodiment, the terminal device 20 is connected to the network 40 via the communication unit 21. The terminal device 20 can thus communicate with the server 30 etc.

The output unit 22 outputs information in the form of, e.g., an image, text, or sound. The output unit 22 includes an output device such as a display or a speaker.

The input unit 23 receives an input operation. The input unit 23 includes an input device such as a touch panel, physical keys, a camera, a microphone, or an integrated circuit (IC) card reader.

The storage unit 24 is, e.g., a semiconductor memory, a magnetic memory, or an optical memory. The storage unit 24 may function as, e.g., a main storage device, an auxiliary storage device, or a cache memory. The storage unit 24 stores any information that is used for operation of the terminal device 20. The storage unit 24 stores, e.g., a system program, an application program, or embedded software. The information stored in the storage unit 24 may be updatable with, e.g., information that is acquired from the network 40 via the communication unit 21.

The control unit 25 includes one or more processors. The processor may be, e.g., a general-purpose processor such as a CPU or a dedicated processor specialized in specific processing. The control unit 25 need not necessarily include the processor(s) and may include one or more dedicated circuits. The dedicated circuit may be, e.g., an FPGA or an ASIC. The control unit 25 controls the above components such as the communication unit 21, the output unit 22, the input unit 23, and the storage unit 24 in order to implement functions of the terminal device 20 including functions of these components.

### Configuration of Server

The configuration of the server 30 according to the present embodiment will be described with reference to FIG. 5. As shown in the block diagram of FIG. 5, the server 30 includes a communication unit 31, a storage unit 32, and a control unit 33. The communication unit 31, the storage unit 32, and the control unit 33 are connected wired or wireless so that they can communicate with each other.

The communication unit 31 includes a communication module for connecting to the network 40. The communication module is a communication module compliant with a mobile communication standard such as 4G or 5G. The communication module may be a communication module compliant with a standard such as a wired LAN or a wireless LAN. The communication module may be a communication module compliant with a short-range wireless communication standard such as Wi-Fi, Bluetooth, or infrared communication. In the present embodiment, the server 30 is connected to the network 40 via the communication unit 31. The server 30 can thus communicate with, e.g., the vehicle 10 and the terminal device 20.

The storage unit 32 is, e.g., a semiconductor memory, a magnetic memory, or an optical memory. The storage unit 32 may function as, e.g., a main storage device, an auxiliary storage device, or a cache memory. The storage unit 32 stores any information that is used for operation of the server 30. The storage unit 32 stores, e.g., a system program, an application program, or database. The information stored in the storage unit 32 may be updatable with, e.g., information that is acquired from the network 40 via the communication unit 31.

The storage unit 32 has stored therein, e.g., vehicle identifiers (IDs) that uniquely identify the one or more vehicles 10 and terminal IDs that uniquely identify the one or more terminal devices 20. The IDs are also referred to as identification information. The vehicle IDs and the terminal IDs are, e.g., information that is delivered by the server 30. However, the vehicle IDs and the terminal IDs may be unique information given in advance to the vehicles 10 or the terminal devices 20. For example, the vehicle IDs are used to identifiably accumulate the probe data received from each of the vehicles 10.

The storage unit 32 has stored therein information associating the one or more vehicles 10 included in the information processing system 1 with the terminal devices 20 that are used by the users of the vehicles 10 using the vehicle IDs and the terminal IDs. Each vehicle 10 may be associated with any number of terminal devices 20.

The control unit 33 includes one or more processors. The processor may be, e.g., a general-purpose processor such as a CPU or a dedicated processor specialized in specific processing. The control unit 33 need not necessarily include the processor(s) and may include one or more dedicated circuits. The dedicated circuit may be, e.g., an FPGA or an ASIC. The control unit 33 controls the above components such as the communication unit 31 and the storage unit 32 in order to implement functions of the server 30 including functions of these components.

The functions of the server 30 are implemented by executing a program according to the present embodiment by the processor(s) in the computer that is an information processing device. That is, the functions of the server 30 are implemented by software. The program is a program for causing the computer to perform steps included in the operation of the server 30 so that the computer implements functions corresponding to the steps. That is, the program is a program for causing the computer to function as the server 30.

The program can be recorded on a computer-readable non-transitory recording medium. The computer-readable non-transitory recording medium is, e.g., a magnetic recording device, an optical disc, a magneto-optical recording medium, or a semiconductor memory. The program is distributed by, e.g., selling, transferring, or lending a portable recording medium, such as a digital versatile disc (DVD) or a compact disc read only memory (CD-ROM), having the program recorded thereon. Alternatively, the program may be stored in a storage of a predetermined server and be distributed by transferring the program from the predetermined server to other computers. The program may be provided as a program product.

The computer first stores, e.g., the program recorded on the portable recording medium or the program transferred from the predetermined server in a memory. The processor(s) in the computer then reads the program stored in the memory and performs processing according to the read program. The computer may read the program directly from the portable recording medium and perform the processing according to the program. The computer may sequentially perform the processing according to the program every time the program is transferred from the predetermined server to the computer. The program may not be transferred from the predetermined server to the computer, and the computer may perform the processing using what is called an application service provider (ASP) service that allows the computer to implement functions by merely sending execution instructions and acquiring results. The program includes information that is provided for processing by the computer and that is equivalent to the program. For example, data that is not direct commands for the computer but has properties that define processing of the computer falls under the “information that is equivalent to the program.”

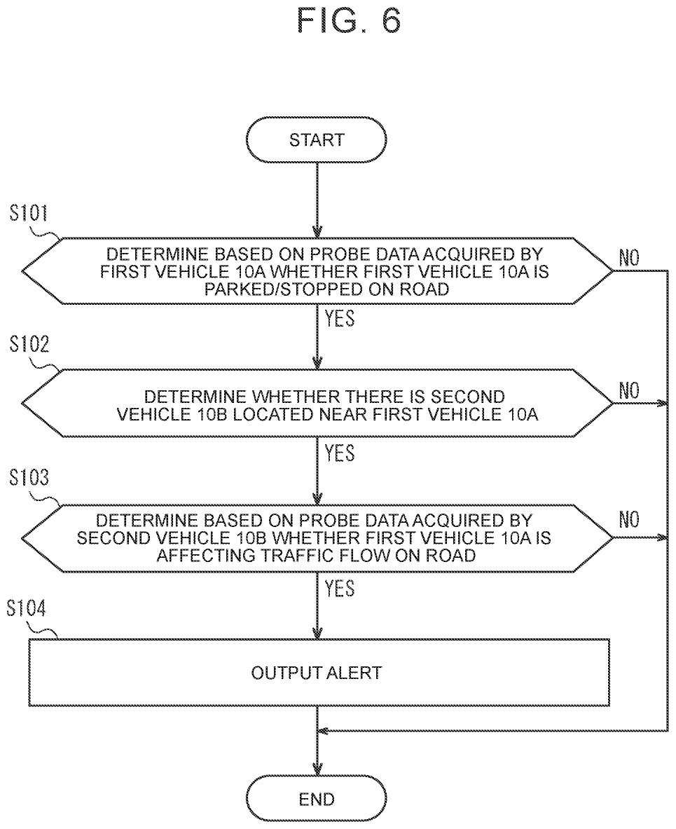

The operation of the server 30 according to the present embodiment will be described with reference to FIG. 6. This operation corresponds to an information processing method according to the present embodiment. In the present embodiment, it is assumed that the server 30 has stored in the storage unit 32 the probe data acquired by the vehicles 10 including the first vehicle 10A, the second vehicle 10B, and the third vehicle 10C.

In the present embodiment, it is assumed that the server 30 performs the processing for, e.g., the first vehicle 10A out of the vehicles 10. However, the server 30 need not necessarily perform the processing for only the first vehicle 10A, and can perform processing similar to the processing for all of the vehicles 10, e.g., serially or in parallel. For example, the server 30 may repeatedly perform the processing at the time the probe data stored in the storage unit 32 is updated.

In step S101, the control unit 33 of the server 30 determines based on the probe data acquired by the first vehicle 10A whether the first vehicle 10A is parked/stopped on a road.

Specifically, the control unit 33 determines whether the probe data acquired by the first vehicle 10A includes information indicating that the first vehicle 10A is parked/stopped on a road. For example, the information indicating that the vehicle 10 is parked/stopped includes information indicating that hazard lights are on, that the vehicle speed of the vehicle 10 is 0 km/hour, that a gear shift of the vehicle 10 is in park (P), or that an engine of the vehicle 10 is off.

The control unit 33 may also determine that the first vehicle 10A is parked/stopped in the case where the probe data acquired by the first vehicle 10A includes information indicating that the first vehicle 10A has been continuously parked/stopped for a predetermined period. The predetermined period may be, e.g., 5 minutes. The control unit 33 may determine that the first vehicle 10A is parked/stopped in the case where the probe data acquired by the first vehicle 10A at a plurality of points of time rather than at only one point of time includes the information indicating that the first vehicle 10A is parked/stopped.

When the control unit 33 determines based on the probe data acquired by the first vehicle 10A that the first vehicle 10A is not parked/stopped on a road (step S101, NO), the control unit 33 ends the processing.

On the other hand, when the control unit 33 of the server 30 determines that the first vehicle 10A is parked/stopped (step S101, YES), the control unit 33 performs step S102 and the subsequent steps to determine based on the probe data acquired by the second vehicle 10B located near the first vehicle 10A whether the first vehicle 10A is affecting traffic flow on the road.

In step S102, the control unit 33 of the server 30 determines whether there is the second vehicle 10B located near the first vehicle 10A.

Specifically, the control unit 33 specifies the position of the parked/stopped first vehicle 10A based on the probe data acquired by the first vehicle 10A. The control unit 33 may determine that an area in a predetermined distance range from the position of the first vehicle 10A is an area near the first vehicle 10A. The control unit 33 determines whether the positions of the vehicles 10 other than the first vehicle 10A specified based on the probe data acquired by the vehicles 10 other than the first vehicle 10A are included in the area near the first vehicle 10A, and thus determines whether there is the second vehicle 10B located near the first vehicle 10A. The second vehicle 10B is not limited to one vehicle, and there may be a plurality of second vehicles 10B.

When the control unit 33 determines that there is no second vehicle 10B located near the first vehicle 10A (step S102, NO), the control unit 33 determines that the first vehicle 10A is parked/stopped on the road but is not affecting the traffic flow on the road because there is no vehicle traveling near the first vehicle 10A. The control unit 33 then ends the processing.

When the control unit 33 of the server 30 determines that there is the second vehicle 10B located near the first vehicle 10A (step S102, YES), the control unit 33 determines in step S103 whether the first vehicle 10A is affecting the traffic flow on the road, based on the probe data acquired by the second vehicle 10B located near the first vehicle 10A.

Specifically, as illustrated below, the control unit 33 determines whether the first vehicle 10A is affecting the traffic flow on the road by comparing the driving state of the second vehicle 10B based on the probe data acquired by the second vehicle 10B with a predetermined condition regarding the driving state of the vehicles. The predetermined condition may be determined for each road according to, e.g., the characteristics of the road such as visibility or presence or absence of a curve, or the speed limit set for the road.

For example, the control unit 33 may determine based on the probe data acquired by the second vehicle 10B whether the second vehicle 10B has been maneuvered to avoid the first vehicle 10A. In this case, the control unit 33 determines whether the probe data acquired by the second vehicle 10B includes information indicating that the second vehicle 10B has been maneuvered to avoid the first vehicle 10A. For example, the information indicating that the second vehicle 10B has been maneuvered to avoid the first vehicle 10A includes information indicating that the second vehicle 10B has been steered by a predetermined amount or more, that a turn signal of the second vehicle 10B has been on, or that the second vehicle 10B is swerving across a lane marking or is straddling lanes. When the control unit 33 determines that the second vehicle 10B has been maneuvered to avoid the first vehicle 10A, the control unit 33 determines that the first vehicle 10A is affecting the traffic flow on the road.

In another example, the control unit 33 may determine based on the probe data acquired by the second vehicle 10B whether the second vehicle 10B has slowed down near the first vehicle 10A. In this case, the control unit 33 determines whether the probe data acquired by the second vehicle 10B includes information indicating that the second vehicle 10B has slowed down near the first vehicle 10A. For example, the information indicating that the second vehicle 10B has slowed down near the first vehicle 10A includes information indicating that the vehicle speed has decreased by a predetermined amount or more, that the brakes have been applied, or that the second vehicle 10B has traveled at a predetermined vehicle speed or less. When the control unit 33 determines that the second vehicle 10B has slowed down near the first vehicle 10A, the control unit 33 determines that the first vehicle 10A is affecting the traffic flow on the road.

In still another example, the control unit 33 may determine based on the probe data acquired by the second vehicle 10B whether there is a traffic jam near the first vehicle 10A. In this case, the control unit 33 determines whether the probe data acquired by the second vehicle 10B includes information indicating that there is a traffic jam near the first vehicle 10A. For example, the information indicating that there is a traffic jam near the first vehicle 10A includes information indicating that the second vehicle 10B has repeatedly sped up and slowed down near the first vehicle 10A or that the second vehicle 10B has traveled a predetermined amount or more of distance or time at a predetermined vehicle speed or less. When the control unit 33 determines that there is a traffic jam near the first vehicle 10A, the control unit 33 determines that the first vehicle 10A is affecting the traffic flow on the road.

In the above determination, the control unit 33 may determine whether the first vehicle 10A is affecting the traffic flow on the road by comparing the driving state of the second vehicle 10B based on the probe data acquired by the second vehicle 10B with the driving state of the vehicle(s) 10 that traveled on the road before the first vehicle 10A is parked/stopped. The control unit 33 may specify, from the probe data acquired by the vehicles 10 in the past and accumulated in the storage unit 32, the probe data acquired by the vehicle(s) 10 that traveled on the road before the first vehicle 10A is parked/stopped and may establish a criterion for determining whether the first vehicle 10A is affecting the traffic flow on the road by a statistical method. For example, the control unit 33 may calculate, from the past probe data, an average vehicle speed of the vehicles 10 that travel on the road, an average steering amount of the vehicles 10 that travel on the road, or an average traffic jam length as the determination criterion for each road. The control unit 33 compares the probe data acquired by the second vehicle 10B with the determination criterion. When the control unit 33 determines that the driving state of the second vehicle 10B is worse than the driving state of the vehicle(s) 10 that traveled on the road before the first vehicle 10A is parked/stopped, the control unit 33 can determine that the first vehicle 10A is affecting the traffic flow on the road.

In the above determination, the control unit 33 may determine that the first vehicle 10A is affecting the traffic flow on the road when the control unit 33 determines that the first vehicle 10A is affecting the driving state of a plurality of second vehicles 10B. The control unit 33 may determine that the first vehicle 10A is parked/stopped when the control unit 33 determines based on the probe data acquired by a plurality of second vehicles 10B rather than by only one second vehicle 10B that the first vehicle 10A is affecting the driving state of the second vehicles 10B. For example, the control unit 33 may determine that the first vehicle 10A is parked/stopped when the control unit 33 determines based on the probe data acquired by two or more second vehicles 10B located near the first vehicle 10A that all of the two or more second vehicles 10B have been maneuvered to avoid the first vehicle 10A.

When the control unit 33 determines that the first vehicle 10A is not affecting the traffic flow on the road (step S103, NO), the control unit 33 determines that the first vehicle 10A is parked/stopped on the road but is not affecting the traffic flow on the road. The control unit 33 then ends the processing.

When the control unit 33 of the server 30 determines that the first vehicle 10A is affecting the traffic flow on the road (step S103, YES), the control unit 33 outputs an alert in step S104 as illustrated below.

For example, the control unit 33 may output an alert to the on-board device mounted on the first vehicle 10A.

Specifically, the control unit 33 sends to the on-board device mounted on the first vehicle 10A via the communication unit 31 an instruction to output a message “Your vehicle is causing a traffic jam. Please refrain from parking/stopping.” to the output unit 14. The user who is in the first vehicle 10A can thus receive the message via the on-board device of the first vehicle 10A.

In another example, the control unit 33 may output an alert to the terminal device 20A that is used by the user of the first vehicle 10A.

Specifically, the control unit 33 specifies the terminal device 20A that is used by the user of the first vehicle 10A, based on the information stored in the storage unit 32 which associates the vehicles 10 with the terminal devices 20 that are used by the users of the vehicles 10. The control unit 33 sends to the terminal device 20A that is used by the user of the first vehicle 10A via the communication unit 31 an instruction to output a message “Your vehicle is causing a traffic jam. Please refrain from parking/stopping.” to the output unit 22. The user of the first vehicle 10A can thus receive the message via the terminal device 20A even when the user is not in the first vehicle 10A.

The control unit 33 may change where to output the alert according to whether the user is in the first vehicle 10A. For example, the control unit 33 may determine whether the user is in the first vehicle 10A by analyzing a captured image of the inside of the first vehicle 10A. When the user is in the first vehicle 10A, the control unit 33 may send to the on-board device mounted on the first vehicle 10A an instruction to output a message “Your vehicle is causing a traffic jam. Please refrain from parking/stopping.” to the output unit 14. When the user is not in the first vehicle 10A, the control unit 33 may send to the terminal device 20A that is used by the user of the first vehicle 10A an instruction to output a message “Your vehicle is causing a traffic jam. Please refrain from parking/stopping.” to the output unit 22.

In still another example, the control unit 33 outputs an alert to the on-board device mounted on the third vehicle 10C that is going to travel near the first vehicle 10A.

Specifically, the control unit 33 determines based on the probe data acquired by the third vehicle 10C whether the third vehicle 10C is going to travel near the first vehicle 10A.

For example, the control unit 33 may determine whether the third vehicle 10C is going to travel near the first vehicle 10A, based on information that is included in the probe data acquired by the third vehicle 10C and that indicates either or both of the position and the traveling direction of the third vehicle 10C.

When the control unit 33 determines that the third vehicle 10C is going to travel near the first vehicle 10A, the control unit 33 sends to the on-board device mounted on the third vehicle 10C via the communication unit 31 an instruction to output an alert message “There is a parked/stopped vehicle ahead. Please use caution.” to the output unit 14. Alternatively, the control unit 33 sends to the on-board device mounted on the third vehicle 10C via the communication unit 31 an instruction to output a message urging a route change “There is a parked/stopped vehicle ahead. Please use other route.” to the output unit 14. The user who is in the third vehicle 10C can thus receive the message via the on-board device of the third vehicle 10C.

When outputting the above alert, the control unit 33 may change either or both of where to output the alert and the content of the alert according to the extent to which the first vehicle 10A is affecting the traffic flow on the road.

Specifically, the control unit 33 may determine whether the first vehicle 10A is affecting the traffic flow on the road by using a plurality of stepwise criteria for determining the extent to which the first vehicle 10A is affecting the traffic flow on the road. The control unit 33 may change the alert to be output according to the determined extent to which the first vehicle 10A is affecting the traffic flow on the road.

For example, the control unit 33 may output the alert to the on-board device of the first vehicle 10A when the first vehicle 10A is affecting the traffic flow on the road to a small extent. The control unit 33 may output the alert to the terminal device 20A of the user of the first vehicle 10A in addition to the on-board device of the first vehicle 10A when the first vehicle 10A is affecting the traffic flow on the road to a large extent. Accordingly, even when the user of the first vehicle 10A is not in the first vehicle 10A, he or she can know via the terminal device 20A that the first vehicle 10A is affecting the traffic flow on the road. The control unit 33 may change where to output the alert according to the extent to which the first vehicle 10A is affecting the traffic flow on the road.

Alternatively, the control unit 33 may change the content of the message to be output to the terminal device 20 or the on-board device according to whether the first vehicle 10A is affecting the traffic flow on the road to a small extent or a large extent. The control unit 33 may thus change the content of the alert to be output according to the extent to which the first vehicle 10A is affecting the traffic flow on the road. The control unit 33 may output the alert message to the on-board device of the third vehicle 10C when the first vehicle 10A is affecting the traffic flow on the road to a small extent. The control unit 33 may output the message urging a route change to the on-board device of the third vehicle 10C when the first vehicle 10A is affecting the traffic flow on the road to a large extent.

As described above, the server 30 according to the present embodiment includes the control unit 33 that determines based on probe data acquired by the first vehicle 10A whether the first vehicle 10A is parked or stopped on a road, that determines based on probe data acquired by one or more second vehicles 10B located near the first vehicle 10A whether the first vehicle 10A is affecting traffic flow on the road, when the control unit 33 determines that the first vehicle 10A is parked or stopped, and that outputs an alert when the control unit 33 determines that the first vehicle 10A is affecting the traffic flow on the road. According to this configuration, the server 30 can output the alert to the first vehicle 10A that is parked or stopped on the road and is affecting the traffic flow on the road. The server 30 thus improves the usefulness of the technique of detecting the vehicle 10 parked or stopped on a road.

In the server 30 according to the present embodiment, the control unit 33 can determine that the first vehicle 10A is parked or stopped when the probe data acquired by the first vehicle 10A includes information indicating that the first vehicle 10A has been continuously parked or stopped for a predetermined period. According to this configuration, the server 30 can exclude the first vehicle 10A, which has been parked or stopped for a short period and has a low probability of affecting the traffic flow on the road, from the subsequent processing. This configuration reduces the processing load on the server 30.

In the server 30 according to the present embodiment, the control unit 33 can determine that the first vehicle 10A is affecting the traffic flow on the road when the control unit 33 determines based on the probe data acquired by the one or more second vehicles 10B that the one or more second vehicles 10B have been maneuvered to avoid the first vehicle 10A. According to this configuration, the server 30 has improved accuracy in determining whether the first vehicle 10A is affecting the traffic flow on the road.

In the server 30 according to the present embodiment, the control unit 33 can determine that the first vehicle 10A is affecting the traffic flow on the road when the control unit 33 determines based on the probe data acquired by the one or more second vehicles 10B that the one or more second vehicles 10B have slowed down near the first vehicle 10A. According to this configuration, the server 30 has improved accuracy in determining whether the first vehicle 10A is affecting the traffic flow on the road.

In the server 30 according to the present embodiment, the control unit 33 can determine that the first vehicle 10A is affecting the traffic flow on the road when the control unit 33 determines based on the probe data acquired by the one or more second vehicles 10B that there is a traffic jam near the first vehicle 10A. According to this configuration, the server 30 has improved accuracy in determining whether the first vehicle 10A is affecting the traffic flow on the road.

In the server 30 according to the present embodiment, the control unit 33 can determine whether the first vehicle 10A is affecting the traffic flow on the road by comparing a driving state of the one or more second vehicles 10B based on the probe data acquired by the one or more second vehicles 10B with a driving state of a vehicle that traveled on the road before the first vehicle 10A is parked or stopped. According to this configuration, the server 30 has a reduced probability of erroneously determining that the first vehicle 10A is affecting the traffic flow on the road, regarding, e.g., roads where a traffic jam tends to occur regularly regardless of whether the first vehicle 10A is parked/stopped. The server 30 thus has improved accuracy in determining whether the first vehicle 10A is affecting the traffic flow on the road.

In the server 30 according to the present embodiment, the control unit 33 can determine that the first vehicle 10A is affecting the traffic flow on the road when the control unit 33 determines that the first vehicle 10A is affecting the driving state of the plurality of second vehicles 10B. According to this configuration, the server 30 has a reduced probability of erroneously determining that the first vehicle 10A is affecting the traffic flow on the road due to, e.g., an accidental change in driving state of one second vehicle 10B. The server 30 thus has improved accuracy in determining whether the first vehicle 10A is affecting the traffic flow on the road.

In the server 30 according to the present embodiment, the control unit 33 can output the alert to an on-board device mounted on the first vehicle 10A. According to this configuration, the server 30 can notify the user who is in the first vehicle 10A that the first vehicle 10A is affecting the traffic flow on the road.

In the server 30 according to the present embodiment, the control unit 33 can output the alert to the terminal device 20A used by the user of the first vehicle 10A. According to this configuration, the server 30 can notify the user that the first vehicle 10A is affecting the traffic flow on the road even when the user is not in the first vehicle 10A.

In the server 30 according to the present embodiment, the control unit 33 can output the alert to the on-board device mounted on the third vehicle 10C that is going to travel near the first vehicle 10A. According to this configuration, the server 30 can alert the user of the third vehicle 10C that is going to travel near the first vehicle 10A.

In the server 30 according to the present embodiment, the control unit 33 can determine based on the probe data acquired by the third vehicle 10C whether the third vehicle 10C is going to travel near the first vehicle 10A. According to this configuration, the server 30 can automatically select the third vehicle 10C that is going to travel near the first vehicle 10A.

In the server 30 according to the present embodiment, the control unit 33 can determine either or both of where to output the alert and the content of the alert according to the extent to which the first vehicle 10A is affecting the traffic flow on the road. According to this configuration, the server 30 further improves the usefulness of the technique of detecting the vehicle 10 parked or stopped on a road.

Although the present disclosure is described based on the drawings and the embodiment, it should be noted that those skilled in the art can make various variations and modifications based on the present disclosure. Therefore, these variations and modifications are included in the scope of the present disclosure. For example, functions etc. included in each unit, each step, etc. can be rearranged so as not to be logically inconsistent, and a plurality of units, a plurality of steps, etc. can be combined into one or divided.

For example, all or a part of the functions or processes described as the functions or processes of the server 30 in the above embodiment may be implemented as the functions or processes of the vehicle 10 or the terminal device 20. In this case, the vehicle 10 or the terminal device 20 may be configured to be equipped with a computer having the above configurations and functions as the configurations and functions of the server 30.

What is claimed is:

1. A server comprising a control unit configured to:
determine based on probe data acquired by a first vehicle whether the first vehicle is parked or stopped on a road;
determine based on probe data acquired by one or more second vehicles located near the first vehicle whether the first vehicle is affecting traffic flow on the road, when the control unit determines that the first vehicle is parked or stopped; and
output an alert when the control unit determines that the first vehicle is affecting the traffic flow on the road.

2. The server according to claim 1, wherein the control unit is configured to determine that the first vehicle is parked or stopped when the probe data acquired by the first vehicle includes information indicating that the first vehicle has been continuously parked or stopped for a predetermined period.

3. The server according to claim 1, wherein the control unit is configured to determine that the first vehicle is affecting the traffic flow on the road when the control unit determines based on the probe data acquired by the one or more second vehicles that the one or more second vehicles have been maneuvered to avoid the first vehicle.

4. The server according to claim 1, wherein the control unit is configured to determine that the first vehicle is affecting the traffic flow on the road when the control unit determines based on the probe data acquired by the one or more second vehicles that the one or more second vehicles have slowed down near the first vehicle.

5. The server according to claim 1, wherein the control unit is configured to determine that the first vehicle is affecting the traffic flow on the road when the control unit determines based on the probe data acquired by the one or more second vehicles that a traffic near the first vehicle is jammed.

6. The server according to claim 1, wherein the control unit is configured to determine whether the first vehicle is affecting the traffic flow on the road by comparing a driving state of the one or more second vehicles based on the probe data acquired by the one or more second vehicles with a driving state of a vehicle that traveled on the road before the first vehicle is parked or stopped.

7. The server according to claim 1, wherein the control unit is configured to determine that the first vehicle is affecting the traffic flow on the road when the control unit determines that the first vehicle is affecting a driving state of the one or more second vehicles.

8. The server according to claim 1, wherein the control unit is configured to output the alert to an on-board device mounted on the first vehicle.

9. The server according to claim 1, wherein the control unit is configured to output the alert to a terminal device used by a user of the first vehicle.

10. The server according to claim 1, wherein the control unit is configured to output the alert to an on-board device mounted on a third vehicle that is going to travel near the first vehicle.

11. The server according to claim 10, wherein the control unit is configured to determine based on probe data acquired by the third vehicle whether the third vehicle is going to travel near the first vehicle.

12. The server according to claim 1, wherein the control unit is configured to determine either or both of where to output the alert and content of the alert according to an extent to which the first vehicle is affecting the traffic flow on the road.

13. A non-transitory storage medium storing instructions that are executable by one or more processors and that cause the one or more processors to perform functions comprising:
determining based on probe data acquired by a first vehicle whether the first vehicle is parked or stopped on a road;
determining based on probe data acquired by one or more second vehicles located near the first vehicle whether the first vehicle is affecting traffic flow on the road, when the one or more processors determine that the first vehicle is parked or stopped; and
outputting an alert when the one or more processors determine that the first vehicle is affecting the traffic flow on the road.

14. The non-transitory storage medium according to claim 13, wherein the instructions cause the one or more processors to determine that the first vehicle is parked or stopped when the probe data acquired by the first vehicle includes information indicating that the first vehicle has been continuously parked or stopped for a predetermined period.

15. The non-transitory storage medium according to claim 13, wherein the instructions cause the one or more processors to determine that the first vehicle is affecting the traffic flow on the road when the one or more processors determine based on the probe data acquired by the one or more second vehicles that the one or more second vehicles have been maneuvered to avoid the first vehicle.

16. The non-transitory storage medium according to claim 13, wherein the instructions cause the one or more processors to determine that the first vehicle is affecting the traffic flow on the road when the one or more processors determine based on the probe data acquired by the one or more second vehicles that the one or more second vehicles have slowed down near the first vehicle.

17. A method for processing information by a computer, comprising:
determining based on probe data acquired by a first vehicle whether the first vehicle is parked or stopped on a road;
determining based on probe data acquired by one or more second vehicles located near the first vehicle whether the first vehicle is affecting traffic flow on the road, when the computer determines that the first vehicle is parked or stopped; and
outputting an alert when the computer determines that the first vehicle is affecting the traffic flow on the road.

18. The method according to claim 17, wherein determining whether the first vehicle is parked or stopped on the road includes determining that the first vehicle is parked or stopped when the probe data acquired by the first vehicle includes information indicating that the first vehicle has been continuously parked or stopped for a predetermined period.

19. The method according to claim 17, wherein determining whether the first vehicle is affecting the traffic flow on the road includes determining that the first vehicle is affecting the traffic flow on the road when the computer determines based on the probe data acquired by the one or more second vehicles that the one or more second vehicles have been maneuvered to avoid the first vehicle.

20. The method according to claim 17, wherein determining whether the first vehicle is affecting the traffic flow on the road includes determining that the first vehicle is affecting the traffic flow on the road when the computer determines based on the probe data acquired by the one or more second vehicles that the one or more second vehicles have slowed down near the first vehicle.
